(19) United States
(12) Patent Application Publication
(10) Pub. No.: US 2024/0384816 A1
(43) Pub. Date: Nov. 21, 2024

(54) MULTILAYER TUBULAR STRUCTURE HAVING A LOW EXTRACTABLES CONTENT FOR TRANSPORTING HYDROGEN

(71) Applicant: ARKEMA FRANCE, COLOMBES (FR)

(72) Inventors: Fidèle NIZEYIMANA, Serquigny (FR); Nicolas DUFAURE, Serquigny (FR); Antoine GOUPIL, Seoul (KR); Thomas PRENVEILLE, Serquigny (FR)

(73) Assignee: ARKEMA FRANCE, COLOMBES (FR)

(21) Appl. No.: 18/695,922

(22) PCT Filed: Sep. 22, 2022
(86) PCT No.: PCT/FR2022/051783

§ 371 Date: Mar. 27, 2024

(30) Foreign Application Priority Data
Sep. 27, 2021 (FR) FR2110144

(51) Int. Cl. F16L 9/12; B32B 1/08; B32B 27/08; B32B 27/22; B32B 27/30; B32B 27/34

(52) U.S. Cl. CPC F16L 9/12; B32B 1/08; B32B 27/08; B32B 27/22; B32B 27/304; B32B 27/306; B32B 27/34; B32B 2250/24; B32B 2307/558; B32B 2597/00

(57) ABSTRACT

A multilayer tubular structure intended for the transportation of hydrogen, including, from the outside toward the inside, at least one barrier layer and at least one internal layer located below the barrier layer, the internal layer or the combination of the layers and of the other optional layers located below the barrier layer containing, on average, from 0% to 1.5% by weight of plasticizer, with respect respectively to the total weight of the composition of the layer or to the total weight of the combination of the compositions of the layers and of the other optional layers located below the barrier layer, the internal layer exhibiting a content of extractables of less than or equal to 3% by weigh of the sum of the constituents of the composition, the internal layer predominantly including at least one polyamide of aliphatic type or having more than 75% of aliphatic units.

The invention relates to a multilayer tubular structure exhibiting a low content of extractables and to its use for transporting hydrogen.

The invention relates more particularly to tubes present within a motor vehicle. These tubes can, for example, be intended for the transportation of hydrogen to feed a fuel cell.

### PRIOR ART

Hydrogen represents a subject which is currently attracting a great deal of interest on the part of numerous manufacturers, in particular in the motor vehicle field. One of the aims pursued is to provide vehicles which are less and less polluting. Thus, electric or hybrid vehicles comprising a battery are targeted at gradually replacing thermal vehicles, such as gasoline or else diesel vehicles. In point of fact, it turns out that the battery is a relatively complex component of the vehicle. According to the location of the battery in the vehicle, it may be necessary to protect it from impacts and the external environment, which may be at extreme temperatures and at a variable humidity. It is also necessary to avoid any risk of flames.

Furthermore, it is important for its operating temperature not to exceed 55° C. in order not to damage the cells of the battery and to safeguard its service life. Conversely, for example in winter, it may be necessary to raise the temperature of the battery so as to optimize its operation.

Moreover, the electric vehicle still suffers today from several problems, namely the range of the battery, the use in these batteries of rare earth metals, the resources of which are not inexhaustible, recharging times which are much longer than the periods of time for filling a tank, and also a problem of electricity production in the various countries in order to be able to recharge the batteries.

Hydrogen thus represents an alternative to the electric battery, since hydrogen can be converted into electricity by means of a fuel cell and can thus power electric vehicles.

Feeding hydrogen to the fuel cell thus requires the presence both of a hydrogen storage tank in the vehicle and of a pipe for the transportation of the hydrogen from the tank to the fuel cell.

Hydrogen tanks or pipes for the transportation of hydrogen generally consist of a metal or thermoplastic liner (or leaktightness layer) which must prevent the permeation of the hydrogen.

The basic principle is to separate the two essential functions, which are the leaktightness and the mechanical strength, in order to manage them independently of each other. In this type of tank, a liner (or leaktightness sheathing) made of thermoplastic resin is combined with a reinforcing structure consisting of fibers (glass, aramid, carbon), also known as reinforcing sheathing or layer, which make it possible to operate at much higher pressures while reducing the weight and while avoiding the risks of explosive rupture in the event of severe external attacks.

The hydrogen transportation pipe should limit as much as possible the permeation of the hydrogen.

They must exhibit a low permeability to hydrogen; this is because the permeability of the pipe is a key factor in limiting the hydrogen losses of the pipe;
good mechanical (fatigue) properties at low temperatures (−40 to −60° C.);
thermal resistance at 85° C.;

Nevertheless, the fuel cell is very sensitive to various contaminants which degrade its performance quality and its durability.

These contaminants can originate from several sources:
from the hydrogen itself due to its process of manufacture,
from the manufacture of the tank and/or of the pipe for transportation of hydrogen, where various natural constituents, such as volatile organic compounds or water, are trapped in particular in the thermoplastic polymer of the leaktightness layer, and which will subsequently be extracted by the hydrogen in contact with said leaktightness layer,
from the presence in the thermoplastic polymer of constituents which are capable of being subsequently extracted by the hydrogen in contact with said leaktightness layer.

According to Chen et al. (A Review of PEM Hydrogen Fuel Cell Contamination: Impact, Mechanisms and Mitigation, Journal of Power Sources, 165 (2007), 739-756), the hydrogen used as fuel in fuel cells in research, development and demonstration originates mainly from commercially available sources. Processes for the production of hydrogen are mainly carried out by reforming starting from hydrocarbons or from oxygenated hydrocarbons, including methane from natural gas and methanol from biomass, but also by electrolysis, partial oxidation of small organic molecules and hydrolysis of sodium borohydride.

Consequently, a hydrogen transportation pipe used with a fuel cell must not only exhibit the basic characteristics listed above but also the hydrogen, after contact with the leaktightness layer of said tank and/or pipe, must contain only a minimum of contaminants extracted from said leaktightness layer.

This twofold problem is solved by the provision of a multilayer structure of the present invention intended for the transportation of hydrogen.

The present invention relates to a multilayer tubular structure (MLT) intended for the transportation of hydrogen, comprising, from the outside toward the inside, at least one barrier layer (1) and at least one internal layer (2) located below the barrier layer,
said internal layer (2) or the combination of the layers (2) and of the other optional layers located below the barrier layer containing, on average, from 0% to 1.5% by weight of plasticizer, with respect respectively to the total weight of the composition of the layer (2) or to the total weight of the combination of the compositions of the layers (2) and of the other optional layers located below the barrier layer,
said internal layer (2) exhibiting a content of extractables of less than or equal to 3% by weight, in particular of less than 2% by weight, of the sum of the constituents of said composition,
said internal layer (2) predominantly comprising at least one polyamide of aliphatic type or consisting of more than 75% of aliphatic units, said aliphatic polyamide being chosen from:
   a polyamide, denoted A, exhibiting a mean number of carbon atoms per nitrogen atom, denoted C_{A}, of from 4 to 8.5, advantageously from 4 to 7;
   a polyamide, denoted B, and a mean number of carbon atoms per nitrogen atom, denoted C_{B}, of from 7 to 10, advantageously from 7.5 to 9.5;
   a polyamide, denoted C, exhibiting a mean number of carbon atoms per nitrogen atom, denoted C_{C}, of from 9 to 18, advantageously from 10 to 18;
with the proviso that, when said internal layer (2) comprises at least three polyamides, one at least of said polyamides A, B and C is excluded.

It would not be departing from the scope of the invention if the object intended for the transportation of hydrogen were also used for the storage of hydrogen.

The expression “the combination of the layers (2) and of the other optional layers located below the barrier layer” means all the layers present located below the barrier layer.

The inventors have thus found that the absence or at least a very low proportion of plasticizer in the internal layer(s), that is to say the layer(s) located under the barrier layer, made it possible to greatly reduce the proportion of contaminants present in the hydrogen and extracted from said internal layer (2) after contact of the hydrogen with the latter, and the total proportion of said contaminants extracted in the hydrogen being less than or equal to 3% by weight, in particular less than 2% by weight, of the sum of the constituents of said composition.

In one embodiment, the content of extractables is determined according to the standard CSA/ANSI CHMC 2:19.

In another embodiment, the content of extractables is determined by filling said tubular structure with type FAM-B alcohol-containing gasoline at 60° C., for 96 hours, said tubular structure subsequently being emptied of its contents, said contents being filtered into a beaker and allowed to evaporate, the evaporation residue then being weighed and corresponding to the content of extractables.

In yet another embodiment, the content of extractables is determined according to the standard CSA/ANSI CHMC 2:19 or by filling said tubular structure with type FAM-B alcohol-containing gasoline at 60° C., for 96 hours, said tubular structure subsequently being emptied of its contents, said contents being filtered into a beaker and allowed to evaporate, the evaporation residue then being weighed and corresponding to the content of extractables.

The multilayer structures of the invention thus exhibit a good permeability to hydrogen and a low extraction of volatile organic compounds (VOCs).

The expression “said internal layer (2) satisfying a test of contaminants present in the hydrogen and extracted from said internal layer (2) by the hydrogen” means that the proportion of contaminants present in the hydrogen and resulting from the internal layer (2) after contact with the hydrogen, whether a tank or a pipe is concerned, does not exceed the limiting values preventing the proper functioning of the fuel cell.

The standard CSA/ANSI CHMC 2:19 gives details on the procedure used to determine the volatile components in the headspace of a polymer during exposure to hydrogen during service.

The expression “after contact of the hydrogen with the latter” means, just like above, exposure to hydrogen during service.

### Apparatus

The test equipment must comprise the following elements:
(a) a cryofocus to preconcentrate the gas samples;
(b) a gas chromatograph using an appropriate column, connected in series with an appropriate selective mass detector;
(c) headspace vials (40 ml), septa, ring closures and vial sealant;
(d) an analytical balance which can weigh up to 60.0001 g; and
e) a convection oven capable of maintaining a temperature of 70±5° C.

### Test Environment

### Purity of the Hydrogen Gas

The conditioning hydrogen gas must be of known composition and of known purity, as described below.

The purity of the hydrogen gas used to fill the test cell must be, at a minimum, in accordance with the standard ISO 14687:2019, Parts 1 to 3, or SAE J2719 (2015). ISO 14687-2 defines the most stringent hydrogen quality specification, with the lowest threshold values for each impurity among these ISO standards (see Table 1). SAE J2719 also applies to proton exchange membrane (PEM) fuel cell vehicles and is harmonized with ISO 14687-2.

TABLE 1

| Characteristics | | Limit |
|---|---|---|
| Combustible index | Minimum molar fraction | 99.97% |
| Total non-hydrogen gas | — | 300 |

Maximum concentration of the individual contaminants

| | | |
|---|---|---|
| Water | H₂O | 5 |
| Total hydrocarbon | Base CH₄ | 2 |
| Methane | CH₄ | 100 |
| Oxygen | O₂ | 5 |
| Helium | He | 300 |
| Total nitrogen and argon | N₂, Ar | 300 |
| Carbon dioxide | CO₂ | 2 |
| Total carbon monoxide, | Σ CO + CH₂O + CH₂O₂ | 0.2 |
| formaldehyde, and formic | | |
| acid | | |
| Carbon monoxide | CO | 0.2 |
| Formaldehyde | CH₂O | 0.2 |
| Formic acid | CH₂O₂ | 0.2 |
| Total sulfur-based | Base H₂S | 0.004 |
| compounds | | |
| Ammonia | NH₃ | 0.1 |
| Total halogenated | — | 0.05 |
| compounds | | |
| Maximum concentration | — | 1 mg/kg |
| of (liquid and solid) | | |
| particles | | |

* all the values are given in ppm (v/v) unless otherwise specified

### Measurement and Instrumentation

The temperature at which the measurements of the rate of hydrogen transmission are carried out must be controlled to within ±1° C. The test pressure must remain constant to within 1% of the test value.

### Test Procedure

The test procedure is described in the standard ISO 14687:2019 in the section 5.6.

### Regarding the Contaminants

The term “contaminant” is understood in the broad sense of the term starting from the moment when said contaminant is extracted from said leaktightness layer by the hydrogen and is not already present in the hydrogen which is introduced into said multilayer structure to cause the fuel cell of the vehicle to operate, for example due to the process by which the hydrogen is obtained.

For example, the term “contaminant” covers metal cations, such as K⁺, Cu²⁺, Ni²⁺ and Fe³⁺, which can be produced by the stabilizers used in the polyamides, organic or metal stabilizers as such, plasticizers, oligomers, in particular caprolactam and its cyclic dimer 1.8-diazacyclotetradecane-2,7-dione (DCDD), volatile organic compounds, such as NH₃, NOₓ, SOxₓ, N₂, benzoic compounds, O₃, the water absorbed by the polyamide after manufacture of the leaktightness layer, fatty substances, such as oil.

Volatile organic compounds thus exclude all the other materials mentioned in the list above.

The total proportion of said extracted contaminants in the hydrogen is less than or equal to 3% by weight, in particular less than 2% by weight, of the sum of the constituents of said composition. Consequently, this total proportion of said extracted contaminants does not take into account the proportion of contaminants that would originate from the process for the preparation of the hydrogen or from any other source.

Advantageously, the total proportion of said extracted contaminants in the hydrogen is of from 0.01% to 3%, in particular from 0.01% to 2%, more particularly from 0.01% to 1%, in particular from 0.01% to 0.5%, by weight.

In a first alternative form, the extracted contaminants are chosen from plasticizers, stabilizers, oligomers, water, a fatty substance, volatile organic compounds and a mixture of these.

Advantageously, in this first alternative form, the proportion by weight of each individual extracted contaminant is less than or equal to 1%.

In one embodiment of this first alternative form, the constitution of the extracted contaminants is as follows:
up to 1% of plasticizers,
up to 0.5% of stabilizers,
up to 1% of oligomers,
up to 0.5% of water,
up to 0.5% of fatty substance, and
up to 0.5% of volatile organic compounds,
the sum of the extracted contaminants being less than or equal to 3%, in particular less than 2%, by weight, of the sum of the constituents of said composition.

Advantageously, in this embodiment of this first alternative form, the total proportion of said extracted contaminants in the hydrogen is of from 0.01% to 3%, in particular from 0.01% to 2%, more particularly from 0.01% to 1%, in particular from 0.01% to 0.5%, by weight.

More advantageously, in this embodiment of this first alternative form, the proportion by weight of each individual extracted contaminant is less than or equal to 1%.

In a second alternative form, the extracted contaminants are chosen from stabilizers, water, oil, volatile organic compounds and a mixture of these.

Advantageously, in this second alternative form, the proportion by weight of each individual extracted contaminant is less than or equal to 0.5%.

In one embodiment of this second alternative form, the constitution of the extracted contaminants is as follows:
up to 0.5% of stabilizers,
up to 0.5% of water,
up to 0.5% of fatty substance, and
up to 0.5% of volatile organic compounds,
the sum of the contaminants being less than or equal to 2% by weight of the sum of the constituents of said composition.

Advantageously, in this embodiment of this second alternative form, the total proportion of said extracted contaminants in the hydrogen is of from 0.01% to 2%, more particularly from 0.01% to 1%, in particular from 0.01% to 0.5%, by weight.

More advantageously, in this embodiment of this second alternative form, the proportion by weight of each individual extracted contaminant is less than or equal to 0.5%.

### Regarding the Barrier Layer

The expression “barrier layer” denotes a layer having characteristics of low permeability and of good resistance to hydrogen, that is to say that the barrier layer slows down the passage of hydrogen into the other layers of the structure or even to the outside of the structure.

The barrier layer is thus a layer which first and foremost makes it possible not to lose too much hydrogen into the atmosphere by diffusion, thereby making it possible to avoid problems of explosion and of ignition.

Advantageously, the barrier layer (1) is leaktight to hydrogen at 23° C., that is to say the permeability to hydrogen at 23° C. is less than 100 cc·mm/m²·24 h·atm at 23° C. under 0% relative humidity (RH).

The permeability can also be expressed in (cc·mm/m²·24 h·Pa).

The permeability then has to be multiplied by 101 325.

These barrier materials can be polyamides with a low carbon content, that is to say for which the mean number of carbon atoms (C) with respect to the nitrogen atom (N) is less than 9, which are preferably semicrystalline and with a high melting point, polyphthalamides (PPAs), and/or also nonpolyamide barrier materials, such as highly crystalline polymers, such as the copolymer of ethylene and of vinyl alcohol (denoted EVOH hereinafter), indeed even functionalized fluorinated materials, such as functionalized polyvinylidene fluoride (PVDF), the functionalized copolymer of ethylene and of tetrafluoroethylene (ETFE), the functionalized copolymer of ethylene, of tetrafluoroethylene and of hexafluoropropylene (EFEP), functionalized polyphenylene sulfide (PPS) or functionalized polybutylene naphthalate (PBN). If these polymers are not functionalized, then it is possible to add an intermediate tie layer in order to ensure good adhesion within the MLT structure.

In one embodiment, said barrier layer (1) is chosen from an EVOH layer, a fluoropolymer layer, in particular a PVDF layer, and a PPA layer.

Among these barrier materials, EVOHs are particularly advantageous, in particular those richest in vinyl alcohol comonomer, and also those which have been impact-modified, since they make it possible to produce stronger structures.

In another embodiment, the present invention relates to a multilayer tubular structure (MLT) as defined above, in which the barrier layer (1) is an EVOH layer.

In another embodiment, the present invention relates to a multilayer tubular structure (MLT) as defined above, in which the EVOH is an EVOH comprising up to 27% of ethylene.

In another embodiment, the present invention relates to a multilayer tubular structure (MLT) as defined above, in which the EVOH is an EVOH comprising an impact modifier.

In another embodiment, the present invention relates to a multilayer tubular structure (MLT) as defined above, in which the barrier layer (1) is a polyphthalamide (PPA) layer.

The term “PPA” means a composition based predominantly on a polyamide comprising a majority of units which comprise at least one aromatic monomer, in particular polyphthalamide of copolyamide 6.T/x (where x denotes one or more comonomers) type, such as the Zytel HTN products from DuPont, such as the Grivory HT products from EMS, such as the Amodel products from Solvay, such as the Genestar products from Kuraray, such as the PPA compositions based on coPA6T/6I, coPA6T/66, coPA6T/6, on coPA6T/6I/66, on PPA9T, on coPPA9T/x, on PPA10T, on coPPA10T/x.

### Regarding the Polyamides

According to the present patent application, the term “polyamide”, also denoted “PA”, is targeted at:
homopolymers,
copolymers, or copolyamides, based on different amide units, such as, for example, copolyamide 6/12 with amide units derived from lactam-6 and from lactam-12,
polyamide alloys, provided that the polyamide is the predominant constituent.

There also exists a category of copolyamides within the broad sense which, although not preferred, come within the scope of the invention. They are copolyamides comprising not only amide units (which will be predominant, hence the fact that they are to be considered as copolyamides within the broad sense) but also units of nonamide nature, for example ether units. The most well-known examples are PEBAs or polyether-block-amides, and their copolyamide-ester-ether, copolyamide-ether or copolyamide-ester variants. Mention may be made, among these, of PEBA-12, where the polyamide units are the same as those of PA12, and PEBA-6.12, where the polyamide units are the same as those of PA6.12.

Homopolyamides, copolyamides and alloys are also distinguished by their number of carbon atoms per nitrogen atom, it being known that there are as many nitrogen atoms as amide (—CO—NH—) groups.

A polyamide with a high carbon content is a polyamide having a high content of carbon (C) atoms with respect to the nitrogen (N) atom. These are polyamides with approximately at least 9 carbon atoms per nitrogen atom, such as, for example, polyamide-9, polyamide-12, polyamide-11, polyamide-10.10 (PA10.10), copolyamide 12/10.T, copolyamide 11/10.T, polyamide-12.T or polyamide-6.12 (PA6.12). T represents terephthalic acid.

The nomenclature used to define polyamides is described in the standard ISO 1874-1:1992 “Plastics-Polyamide (PA) moulding and extrusion materials—Part 1: Designation”, in particular on page 3 (Tables 1 and 2), and is well known to a person skilled in the art.

A polyamide with a low carbon content is a polyamide having a low content of carbon (C) atoms with respect to the nitrogen (N) atom. These are polyamides with approximately less than 9 carbon atoms per nitrogen atom, such as, for example, polyamide-6, polyamide-6.6, polyamide-4.6, copolyamide-6.T/6.6, copolyamide 6.1/6.6, copolyamide 6.T/6.I/6.6 or polyamide 9.T. I represents isophthalic acid.

In the case of a homopolyamide of PA-X.Y type, with X denoting a unit obtained from a diamine and Y denoting a unit obtained from a diacid, the number of carbon atoms per nitrogen atom is the mean of the numbers of carbon atoms present in the unit resulting from the diamine X and in the unit resulting from the diacid Y. Thus, PA6.12 is a PA having 9 carbon atoms per nitrogen atom, in other words a C₉ PA. PA6.13 is C_{9.5}.

In the case of the copolyamides, the number of carbon atoms per nitrogen atom is calculated according to the same principle. The calculation is carried out on a molar pro rata basis from the various amide units. In the case of a copolyamide having units of nonamide type, the calculation is carried out solely on the portion of amide units. Thus, for example, for PEBA-12, which is a block copolymer of amide-12 units and of ether units, the mean number of carbon atoms per nitrogen atom will be 12, as for PA12; for PEBA-6.12, it will be 9, as for PA6.12.

Thus, polyamides with a high carbon content, such as the polyamide PA12 or 11, adhere with difficulty to an EVOH polymer, to a polyamide with a low carbon content, such as the polyamide PA6, or also to an alloy of polyamide PA6 and of polyolefin (such as, for example, an Orgalloy® sold by Arkema).

### Regarding the Layer (2)

When just one layer (2) is present, it is in contact with the hydrogen.

In the case where several layers (2) are present, it is possible for one of the internal layers to exhibit a proportion of plasticizer of greater than 1.5% by weight but in this case the proportion of plasticizer above 1.5% is compensated for by the thickness of the layer, which is then much thinner, so that the mean value of plasticizer present in the combined internal layers does not exceed 1.5%. The proportion of plasticizer in this layer can then be up to 15% but its thickness then does not exceed 10% of the total thickness of the tube; preferably, it does not exceed 100 μm.

This much thinner layer can be either directly in contact with the barrier layer or be the innermost layer, which is then in contact with the hydrogen.

The expression “said internal layer (2) predominantly comprising at least one polyamide of aliphatic type” means that said polyamide of aliphatic type is present in a proportion of more than 50% by weight in the layer (2). The polyamide of aliphatic type is linear and is not of cycloaliphatic type.

Advantageously, said predominant polyamide of aliphatic type of the layer(s) (2) also predominantly comprises aliphatic units, namely more than 50% of aliphatic units.

Advantageously, said predominant polyamide of aliphatic type of the layer(s) (2) consists of more than 75% of aliphatic units; preferably, said predominant polyamide of aliphatic type of the layer(s) (2) is completely aliphatic.

In an advantageous embodiment, said internal layer (2) or each of the layers (2) and of the other optional layers located below the barrier layer contains from 0% to 1.5% by weight of plasticizer, with respect respectively to the total weight of the composition of the layer (2) or to the total weight of each of the compositions of the layers (2) and of the other optional layers located below the barrier layer.

In an advantageous embodiment, in the multilayer tubular structure (MLT) as defined above, said internal layer (2) or each of the layers (2) and of the other optional layers located below the barrier layer is (are) devoid of plasticizer.

In this embodiment, all the layers located under the barrier layer are completely devoid of plasticizer and constitute one of the preferred structures of the invention.

In one embodiment, PA12 is excluded from the definition of the polyamide C of the layer (2) or of the layers (2) present.

Advantageously, in the multilayer tubular structure (MLT) as defined above, the polyamide of the internal layer (2) is a composition based on a polyamide chosen from A, B or C as defined above, in particular PA6, PA66, PA6/66, PA11, PA610, PA612 or PA1012, the corresponding copolyamides and the blends of said polyamides or copolyamides, the polyamides obtained from a lactam being advantageously washed, and the polyamide of the external layer (3) is a polyamide chosen from B or C as defined above, in particular PA11, PA12, PA610, PA612 or PA1012, the corresponding copolyamides and the blends of said polyamides or copolyamides, the polyamides obtained from a lactam being advantageously washed.

In another embodiment, the present invention relates to a multilayer tubular structure (MLT) as defined below, in which the polyamide of the internal layer (2) or of one at least of the other layers (2) is a conductive polyamide.

When the tubular structure of the invention comprises several layers (2), the conductive layer is that which is innermost, that is to say in contact with the hydrogen.

Advantageously, in the multilayer tubular structure (MLT) as defined above, the polyamide of the internal layer (2) is a composition based on a polyamide chosen from A, B or C as defined above, in particular PA6, PA66, PA6/66, PA11, PA610, PA612 or PA1012, the corresponding copolyamides and the blends of said polyamides or copolyamides, the polyamides obtained from a lactam being advantageously washed.

Regarding the Layer (3)

In an advantageous embodiment, the present invention relates to a multilayer tubular structure (MLT) as defined above, in which at least one, more external, layer (3), located above the barrier layer, is present, said external layer (3) predominantly comprising at least one polyamide of aliphatic type or consisting of more than 75% of aliphatic units, in particular said aliphatic polyamide exhibiting a mean number of carbon atoms per nitrogen atom of from 9.5 to 18, advantageously from 11 to 18.

The expression “said external layer (3) predominantly comprising at least one polyamide of aliphatic type” means that said polyamide of aliphatic type is present in a proportion of more than 50% by weight in the layer (3). The polyamide of aliphatic type is linear and is not of cycloaliphatic type.

Advantageously, said predominant polyamide of aliphatic type of the layer(s) (3) also predominantly comprises aliphatic units, namely more than 50% of aliphatic units.

Advantageously, said predominant polyamide of aliphatic type of the layer(s) (3) consists of more than 75% of aliphatic units; preferably, said predominant polyamide of aliphatic type of the layer(s) (3) is completely aliphatic.

Advantageously, said predominant polyamide of aliphatic type of the layer(s) (2) and of the layer(s) (3) also predominantly comprises aliphatic units, namely more than 50% of aliphatic units.

Advantageously, said predominant polyamide of aliphatic type of the layer(s) (2) and of the layer(s) (3) consists of more than 75% of aliphatic units; preferably, said predominant polyamide of aliphatic type of the layer(s) (2) and of the layer(s) (3) is completely aliphatic.

Advantageously, the present invention relates to a multilayer tubular structure (MLT) as defined above, in which said external layer (3) comprises from 0% to 15% of plasticizer, with respect to the total weight of the composition of the layer (3), or in which the combined external layers comprise, on average, from 0% to 5% of plasticizer.

It is possible to have a greater proportion of plasticizer in the external layer(s), that is to say the layer(s) located above the barrier layer, without however significantly increasing the proportion of extractables.

As already indicated above for the layers (2), in the case where several layers (3) are present, it is possible for one of the external layers to exhibit a greater proportion of plasticizer, such as 15% by weight, but in this case the proportion of plasticizer is compensated for by the thickness of the layer, which is then much thinner, so that the mean value of plasticizer present in the combined internal layers does not exceed 5%. The proportion of plasticizer in this layer can then be up to 15% but its thickness does not exceed 20% of the total thickness of the tube; preferably, it does not exceed 200 μm.

### Regarding the Layer (3′)

Advantageously, the present invention relates to a multilayer tubular structure (MLT) comprising a layer (3) as defined above, in which at least one second external layer (3′) located above the barrier layer is present, and preferably located above the layer (3), said layer (3′) being plasticized, said plasticizer being in particular present in a proportion of from 1.5% to 15% by weight, with respect to the total weight of the composition of said layer; the thickness of said layer (3′) preferably represents up to 20% of the total thickness of the tubular structure, in particular up to 200 μm.

The layer (3′), just like the layer (3), predominantly comprises a polyamide of aliphatic type, that is to say that said polyamide of aliphatic type is present in a proportion of more than 50% by weight in the layer (3′). The polyamide of aliphatic type is linear and is not of cycloaliphatic type.

Advantageously, said predominant polyamide of aliphatic type of the layer(s) (3′) also predominantly comprises aliphatic units, namely more than 50% of aliphatic units.

Advantageously, said predominant polyamide of aliphatic type of the layer(s) (3′) consists of more than 75% of aliphatic units; preferably, said predominant polyamide of aliphatic type of the layer(s) (3′) is completely aliphatic.

In another embodiment, the present invention relates to a multilayer tubular structure (MLT), in which the layer(s) (3) comprise(s) up to 1.5% by weight of plasticizer, with respect to the total weight of the composition of said layer or of the combined compositions of the layers (3).

Advantageously, the multilayer tubular structure (MLT) comprises just one layer (3) and is devoid of plasticizer.

Advantageously, the multilayer tubular structure (MLT) comprises just one layer (3) and just one layer (2), the layers (2) and (3) being devoid of plasticizer.

In another embodiment, the present invention relates to a multilayer tubular structure (MLT), in which the content of plasticizer of all the layers located above the barrier layer is at most 5% by weight, with respect to the total weight of the compositions of all the layers located above the barrier layer.

In another embodiment, the present invention relates to a multilayer tubular structure (MLT), in which the layer (3′) is the outermost layer and is the only layer which is plasticized, the layer(s) (3) being devoid of plasticizer.

The proportion of plasticizer can represent up to 15% by weight of the total weight of the composition of the layer (3′). The greater the proportion of plasticizer, the thinner the layer (3′) will be, with a thickness of said layer (3′) which preferably represents up to 20% of the total thickness of the tubular structure, in particular up to 200 μm.

Advantageously, the multilayer tubular structure (MLT) consists of four layers, from the outside toward the inside (3′)//(3)//(1)//(2), the layer (3′) being the only layer plasticized in proportions as defined above, the layer (3) and the layer (2) being devoid of plasticizer.

A multilayer tubular structure (MLT) consisting of four layers, from the outside toward the inside (3′)//(3)//(1)//(2), exhibits the advantage of having an elongation at break at t=0, when the structure is very dry with a very low moisture content of from 0% to 30% relative humidity, which is very good and in particular better than a structure, the layers (3′), (3) and (2) of which are devoid of plasticizer.

Advantageously, in this latter embodiment, the layer (3′) is the outermost layer and the polyamide of the latter is a long-chain polyamide, i.e. having a mean number of carbon atoms per nitrogen atom, denoted Cc, of from 9.5 to 18, the layer (3) is located between the barrier layer and the layer (3′) and the polyamide of this layer (3) is a short-chain polyamide, i.e. having a mean number of carbon atoms per nitrogen atom, denoted Ca, of from 4 to 9.

Advantageously, in this latter embodiment, the layer (3′) has thickness of from 100 to 200 μm, the layer (3) exhibits a thickness of at least 200 μm and the layer (1) exhibits a thickness of from 100 to 200 μm.

Advantageously, in this latter embodiment, the layer (3′) is the outermost layer and the polyamide of the latter is a long-chain polyamide, i.e. having a mean number of carbon atoms per nitrogen atom, denoted Cc, of from 9.5 to 18, the layer (3) is located between the barrier layer and the layer (3′) and the polyamide of this layer (3) is a short-chain polyamide, i.e. having a mean number of carbon atoms per nitrogen atom, denoted Ca, of from 4 to 9, the layer (3′) has a thickness of from 100 to 200 μm, the layer (3) exhibits a thickness of at least 200 μm and the layer (1) exhibits a thickness of from 100 to 200 μm.

Advantageously, the multilayer tubular structure (MLT) consists of five layers, from the outside toward the inside (3′)//(3)//(1)//(2)//(2′), the layer (3′) being the only layer plasticized in proportions as defined above, the layer (3) and the layers (2) and (2′) being devoid of plasticizer, the layer (2′) being a polyamide as defined for the layer (2) but different from that of the layer (2). This type of structure makes it possible to increase the elongation at break under very low humidity conditions, without excessively stiffening the structure.

Whatever the number of layers: three, four, five or more, the preferred tubular structures are those containing as little as possible of plasticizer, and preferably the least amount of plasticizer in the innermost layers, that is to say the layers closest to the fluid. These structures can be as follows:
Multilayer tubular structure (MLT) not containing more than 1.5% of plasticizer in the first 50% of its thickness, starting from the internal face in contact with the hydrogen.
Multilayer tubular structure (MLT) not containing more than 1.5% of plasticizer in the first 75% of its thickness, starting from the internal face in contact with the hydrogen.
Multilayer tubular structure (MLT) not containing more than 1.5% of plasticizer in the first 85% of its thickness, starting from the internal face in contact with the hydrogen.
Multilayer tubular structure (MLT) devoid of plasticizer in the first 50% of its thickness, starting from the internal face in contact with the hydrogen.
Multilayer tubular structure (MLT) devoid of plasticizer in the first 75% of its thickness, starting from the internal face in contact with the hydrogen.
Multilayer tubular structure (MLT) devoid of plasticizer in the first 85% of its thickness, starting from the internal face in contact with the hydrogen.

### Regarding the Layer (4) and the Layer (4′)

In another embodiment, the present invention relates to a multilayer tubular structure (MLT) as defined above, in which at least one layer (4) is present, said layer (4) not containing more than 15% by weight of plasticizer, preferably not more than 1.5% by weight of plasticizer, with respect to the total weight of the constituents of the layer (4); advantageously, the layer (4) is devoid of plasticizer, said layer (4) predominantly comprising at least one polyamide of aliphatic type or consisting of more than 75% of aliphatic units, said aliphatic polyamide being chosen from:
a polyamide, denoted A, exhibiting a mean number of carbon atoms per nitrogen atom, denoted CA, of from 4 to 8.5, advantageously from 4 to 7;
a polyamide, denoted B, and a mean number of carbon atoms per nitrogen atom, denoted CB, of from 7 to 10, advantageously from 7.5 to 9.5;
a polyamide, denoted C, exhibiting a mean number of carbon atoms per nitrogen atom, denoted CC, of from 9 to 18, advantageously from 10 to 18;
with the proviso that, when said layer (4) comprises at least three polyamides, at least one of said polyamides A, B and C is excluded,
said layer (4) being located between the barrier layer (1) and the internal layer (2) and/or between the external layer (3) and the barrier layer (1);
or said layer (4) is a tie layer, the thickness of which represents up to 15% of the (MLT) structure.

The layer (4), when it is not a tie layer, is a polyamide of aliphatic type as defined for the layers (2), (3) and (3′).

Advantageously, the tubular structure of the invention is a four-layer structure consisting, from the outside toward the inside, of the following layers: (3)//(4)//(1)//(2), the layer (3) being plasticized up to 15% as above and thin, and the layer (4), when it is different from the tie layer as defined above, is devoid of plasticizer, and also the layer (2).

Advantageously, the tubular structure of the invention is a four-layer structure consisting, from the outside toward the inside, of the following layers: (3)//(1)//(4)//(2), the layer (3) being plasticized up to 15% by weight as above and preferably thin, and the layer (4), when it is different from the tie layer as defined above, is devoid of plasticizer, and also the layer (2).

Nevertheless, this layer (3) plasticized up to 15% by weight must not be too thin, otherwise the barrier layer is not central enough and the MLT structure risks not being good enough in terms of impact. On the other hand, it can be very thin if there is an additional thick (nonplasticized) layer between the layer (3) and the layer (1), so that the layer (1) is not excessively off-center.

Another layer (2′) and/or a layer (3′) can also be present in these two types of four-layer structures.

Said layer (4) can also be a tie, as described in particular in the patents EP 1 452 307 and EP 1 162 061, EP 1 216 826 and EP 0 428 833.

It is implicit that the layers (3) and (1) or (1) and (2) adhere together. The tie layer is intended to be interposed between two layers which do not adhere together or which adhere together with difficulty.

The tie can be, for example, but without being limited to these, a composition based on 50% of copolyamide 6/12 (of 70/30 ratio by weight) with an Mn of 16 000 and on 50% of copolyamide 6/12 (of 30/70 ratio by weight) with an Mn 16 000, a composition based on PP (polypropylene) grafted with maleic anhydride, known under the name of Admer QF551A from Mitsui, a composition based on PA610 (with an Mn of 30 000, and as defined elsewhere) and on 36% of PA6 (with an Mn of 28 000) and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba), a composition based on PA612 (with an Mn of 29 000, and as defined elsewhere) and on 36% of PA6 (with an Mn of 28 000, and as defined elsewhere) and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba), a composition based on PA610 (with an Mn of 30 000, and as defined elsewhere) and on 36% of PA12 (with an Mn of 35 000, and as defined elsewhere) and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba), a composition based on 40% of PA6 (with an Mn of 28 000, and as defined elsewhere), on 40% PA12 (Mn 35 000, and as defined elsewhere) and on 20% of functionalized EPR Exxelor VA1801 (Exxon), and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba), or also a composition based on 40% of PA6.10 (with an Mn of 30 000, and as defined elsewhere), on 40% of PA6 (with an Mn of 28 000, and as defined elsewhere) and on 20% of impact modifier of ethylene/ethyl acrylate/anhydride type in a 68.5/30/1.5 ratio by weight (MFI 6 at 190° C. under 2.16 kg), and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba).

In another embodiment, the present invention relates to a multilayer tubular structure (MLT) as defined above, in which a layer (4′) is present, said layer (4′) predominantly comprising at least one polyamide of aliphatic type or consisting of more than 75% of aliphatic units, said aliphatic polyamide being chosen from:
a polyamide, denoted A, exhibiting a mean number of carbon atoms per nitrogen atom, denoted CA, of from 4 to 8.5, advantageously from 4 to 7;
a polyamide, denoted B, and a mean number of carbon atoms per nitrogen atom, denoted CB, of from 7 to 10, advantageously from 7.5 to 9.5;
a polyamide, denoted C, exhibiting a mean number of carbon atoms per nitrogen atom, denoted CC, of from 9 to 18, advantageously from 10 to 18;
with the proviso that, when said layer (4′) comprises at least three polyamides, one at least of said polyamides A, B and C is excluded,
or said layer (4′) is a tie layer, the thickness of which represents up to 15% of the (MLT) structure,
it being possible for said at least one polyamide of said layer (4′) to be identical to or different from said polyamide of the layer (4);
said layer (4′) being located between the external layer (3) and the barrier layer (1) and said tie layer (4) being located between the barrier layer (1) and the internal layer (2).

The layer (4′) may or may not contain a plasticizer. Advantageously, it is devoid of plasticizer, just like the layer (2) and the layer (4), the layer (3) being plasticized but thin, as defined above.

In another embodiment, the present invention relates to a multilayer tubular structure (MLT) as defined above, in which the polyamide of the internal layer (2) or the polyamide of the external layer (3) is a completely aliphatic polyamide; preferably, the polyamide of the internal layer (2) and the polyamide of the external layer (3) are completely aliphatic polyamides.

Advantageously, in the multilayer tubular structure (MLT) as defined above, the polyamide of the layer (4) and/or (4′) is a blend of a polyamide exhibiting a mean number of carbon atoms per nitrogen atom of 10 or more and a polyamide exhibiting a mean number of carbon atoms per nitrogen atom of 6 or less, for example PA12 and PA6, and an anhydride-functionalized (co)polyolefin.

Advantageously, in the multilayer tubular structure (MLT) as defined above, the polyamide of the layer (4) and/or (4′) is chosen from the binary blends: PA6 and PA12, PA6 and PA612, PA6 and PA610, PA12 and PA612, PA12 and PA610, PA1010 and PA612, PA1010 and PA610, PA1012 and PA612, PA1012 and PA610, and the ternary blends: PA6, PA610 and PA12; PA6, PA612 and PA12; PA6, PA614 and PA12.

### Regarding the Layer (5)

In another embodiment, the present invention relates to a multilayer tubular structure (MLT) as defined above, in which a second barrier layer (5) is present, said second barrier layer (5) being adjacent or not adjacent to the first barrier layer (1) and located below said barrier layer (1).

It can be advantageous, in particular for alcohol-containing gasolines, and very particularly for those containing methanol, to place a second barrier layer in order to limit even more the diffusion of the gasoline into the atmosphere and/or in order to reduce the content of extractables.

This second barrier layer is different from the first barrier layer (1).

### Regarding the Second Barrier Layer

In another embodiment, the present invention relates to a multilayer tubular structure (MLT) as defined above, in which the barrier layer (1) is an EVOH layer and the second barrier layer (5) is a PPA or fluoropolymer layer, the fluoropolymer being in particular of ETFE, EFEP or CPT type.

Advantageously, the barrier layer (1) is a EVOH layer and the second barrier layer (5) is a PPA layer.

In another embodiment, the present invention relates to a multilayer tubular structure (MLT) as defined above, in which the barrier layer (1) is an EVOH layer and the second barrier layer (5) is a PPA layer.

In another embodiment, the present invention relates to a multilayer tubular structure (MLT) as defined above, in which the barrier layer (1) is an EVOH layer and the second barrier layer (5) is a fluoropolymer layer, the fluoropolymer being in particular of ETFE, EFEP or CPT type.

Advantageously, in the multilayer tubular structure (MLT) as defined above, the polyamide of the external layer (3) is a polyamide chosen from B or C as defined above, in particular PA11, PA12, PA610, PA612 or PA1012, the corresponding copolyamides and the blends of said polyamides or copolyamides, the polyamides obtained from a lactam being advantageously washed.

### Various Structural Embodiments

In another embodiment, the present invention relates to a multilayer tubular structure (MLT) as defined above, in which at least one of the layers (2), (3), (3′), (4) and (4′) comprises at least one impact modifier and/or at least one additive.

It is very obvious that the impact modifier or the additive is not a plasticizer.

Advantageously, the layers (2) and (3) comprise at least one impact modifier and/or at least one additive.

Advantageously, the layers (2), (3) and (3′) comprise at least one impact modifier and/or at least one additive.

Advantageously, the layers (2), (3), (3′) and (4′) comprise at least one impact modifier and/or at least one additive.

Advantageously, the layers (2), (3), (3′), (4) and (4′) comprise at least one impact modifier and/or at least one additive.

In another embodiment, the present invention relates to a multilayer tubular structure (MLT) as defined above, in which the structure comprises three layers in the following order: (3)//(1)//(2), the layers (3) and/or (2) not containing more than 1.5% by weight of plasticizer, with respect to the total weight of the composition of each layer; in particular, the layer (3) and/or (2) is (are) devoid of plasticizer.

In another embodiment, the present invention relates to a multilayer tubular structure (MLT) as defined above, in which the structure comprises four layers in the following order: (3′)//(3)//(1)//(2), the layer (3′) being as defined above, the layer (2) and/or (3) not containing more than 1.5% by weight of plasticizer, with respect to the total weight of the composition of each layer; in particular, the layer (2) and/or (3) is (are) devoid of plasticizer.

In another embodiment, the present invention relates to a multilayer tubular structure (MLT) as defined above, in which the structure comprises five layers in the following order:
(3′)//(3)//(1)//(5)//(2), in which the layer (1) is an EVOH layer, the layer (5) is a PPA layer, the layer (2) not containing more than 1.5% by weight of plasticizer, with respect to the total weight of the composition of each layer; in particular, the layer (2) is devoid of plasticizer, the layer (3) and (3′) comprising plasticizer; or
(3′)//(3)//(1)//(2)//(5), in which the layer (1) is an EVOH layer, the layer (5) is a PPA layer, the layer (2) not containing more than 1.5% by weight of plasticizer, with respect to the total weight of the composition of each layer; in particular, the layer (2) is devoid of plasticizer, the layer (3) and (3′) comprising plasticizer; or
(3)//(4′)//(1)//(4)//(2), in which the layer (3) is as defined in claim 3, the layer (2) and (4) not containing more than 1.5% by weight of plasticizer, with respect to the total weight of the composition of each layer; in particular, the layer (2) and/or (4) is (are) devoid of plasticizer; the layer (4′) comprising plasticizer; in particular, the layer (4′) is devoid of plasticizer.

According to another embodiment, the present invention relates to a multilayer tubular structure (MLT) as defined above, in which the structure comprises the layers in the following order:
(3′)//(3)//(4′)//(1)//(4)//(2), in which the layers (3) and (3′) are as defined above, the layer (2) and (4) not containing more than 1.5% by weight of plasticizer, with respect to the total weight of the composition of each layer; in particular, the layer (2) and/or (4) is (are) devoid of plasticizer; the layer (4′) comprising plasticizer; in particular, the layer (4′) is devoid of plasticizer.

In particular, said layer (3′) of the six-layer structure above is plasticized, said plasticizer being in particular present in a proportion of 1.5% to 15% by weight, with respect to the total weight of the composition of said layer; the thickness of said layer (3′) preferably represents up to 20% of the total thickness of the tubular structure, in particular up to 200 μm; in particular, the layer (3′) is the outermost layer and is the only layer which is plasticized, the layer(s) (3) being devoid of plasticizer.

According to another aspect, the present invention relates to a multilayer structure as defined above, characterized in that it comprises a polyamide connector at one and/or the other of its ends, said connector being welded to said structure.

The welding can be carried out, for example, by means of a laser.

The polyamide is chosen from an aliphatic polyamide as defined above and a semiaromatic polyamide, in particular a semiaromatic polyamide of formula X/YAr, as are described in EP 1 505 099, in particular a semiaromatic polyamide of formula A/XT in which A is chosen from a unit obtained from an amino acid, a unit obtained from a lactam and a unit corresponding to the formula (Ca diamine)·(Cb diacid), with a representing the number of carbon atoms of the diamine and b representing the number of carbon atoms of the diacid, a and b each being of between 4 and 36, advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;

XT denotes a unit obtained from the polycondensation of a Cx diamine and terephthalic acid, with x representing the number of carbon atoms of the Cx diamine, x being of between 5 and 36, advantageously between 9 and 18, in particular a polyamide of formula A/5T, A/6T, A/9T, A/10T or A/11T, A being as defined above, in particular a polyamide chosen from a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T, a PA 11/MXDT/10T or a PA 11/5T/10T.

T corresponds to terephthalic acid, MXD corresponds to m-xylylenediamine, MPMD corresponds to methylpentamethylenediamine and BAC corresponds to bis(aminomethyl)cyclohexane.

In one embodiment, PA12 is excluded from the aliphatic polyamide constituting said connector.

In another embodiment, the aliphatic polyamide of said connector is chosen from PA6, PA66, PA6/66, PA11, PA610, PA612 or PA1012, in particular PA11.

In one embodiment, said connector consists of a polyamide composition as defined above, said composition being a fiber-filled composition.

In one embodiment, the fibers are of inorganic, organic or vegetable origin.

Mention may be made, among the fibers of inorganic origin, of carbon fibers, glass fibers, basalt or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example.

Advantageously, the fibers are glass and/or carbon fibers.

According to another aspect, the present invention relates to the use of a multilayer tubular structure (MLT), as defined above, for the transportation of hydrogen.

### EXAMPLES

The invention will now be described in more detail by means of the following examples, which are not limiting.

The following compositions were prepared according to techniques well known to a person skilled in the art for the formation of the internal layer (2) of the structures of the invention (Table 1).

TABLE 1

| Composition | I1 | I2 | I3 | I4 | I5 | C1 | C2 |
|---|---|---|---|---|---|---|---|
| PA11 | 100% | | 99.7% | 90% | 89.7% | 86% | |
| PA11/10T | | 70% | | | | | 65% |
| Plasticizer | 0 | 0% | 0 | 0 | 0 | 13% | 10% |
| Impact | 0% | 30% | 0% | 10% | 10% | 0% | 35% |
| modifier | | | | | | | |
| Additives | 0% | 0% | 0.3% | 0% | 0.3% | 0% | 0% |

Additives: stabilizers
I1 to I2: compositions of the invention
C1 to C2: comparative compositions
PA11: PA11 is a polyamide 11 with an Mn (number-average molecular weight) of 45 000. The melting point is 190° C. and its enthalpy of fusion is 56 J/g.
PA11/10T: Rilsan HT (Arkema)
Plasticizer: BBSA (n-butylbenzenesulfonamide)
Impact modifier: Lotader ® 4700 (50%) + Lotader ® AX8900 (25%) + Lucalene ® 3110 (25%)

The following structures were prepared by extrusion:

The multilayer tubes are produced by coextrusion. A McNeil multilayer extrusion industrial line, equipped with 5 extruders connected to a multilayer extrusion head having spiral mandrels, is used.

The screws used are single extrusion screws having screw profiles suited to polyamides. In addition to the 5 extruders and the multilayer extrusion head, the extrusion line comprises:
a die-punch assembly, located at the end of the coextrusion head; the internal diameter of the die and the external diameter of the punch are chosen as a function of the structure to be produced and of the materials of which it is composed, and also of the dimensions of the tube and of the line speed;
a vacuum tank with an adjustable level of vacuum. Water maintained in general at 20° C. circulates in this tank, into which water a gauge is immersed which makes it possible to form the tube into its final dimensions. The diameter of the gauge is suited to the dimensions of the tube to be produced, typically from 8.5 to 10 mm for a tube with an external diameter of 8 mm and with a thickness of 1 mm;
a succession of cooling tanks in which water is maintained at approximately 20° C., making it possible to cool the tube along the path from the head to the drawing bench;
a diameter measurer;
a drawing bench.

The configuration having 5 extruders is used to produce tubes ranging from 2 layers to 5 layers. In the case of the structures in which the number of layers is less than 5, several extruders are then fed with the same material.

In the case of the structures comprising 6 layers, an additional extruder is connected and a spiral mandrel is added to the existing head, with a view to producing the internal layer, in contact with the hydrogen.

Before the tests, in order to provide the tube with the best properties and a good extrusion quality, it is verified that the extruded materials have a residual moisture content before extrusion of less than 0.08%. If this is not the case, an additional stage of drying the material before the tests is carried out, generally in a vacuum dryer, overnight at 80° C.

The tubes, which satisfy the characteristics described in the present patent application, were removed, after stabilization of the extrusion parameters, the targeted dimensions of the tubes no longer changing over time. The diameter is monitored by a laser diameter measurer installed at the end of the line.

Generally, the line speed is typically 20 m/min. It generally varies between 5 and 100 m/min.

The screw speed of the extruders depends on the thickness of the layer and on the diameter of the screw, as is known to a person skilled in the art.

In general, the temperatures of the extruders and items of equipment (head and connector) should be adjusted so as to be sufficiently greater than the melting point of the compositions under consideration, so that they remain in the molten state, thus preventing them from solidifying and blocking the machine.

The tubular structures were tested with regard to different parameters (Table 2).

The amount of extractables was determined and the barrier properties were evaluated.

The content of extractables measured by contact with alcohol-containing gasoline (“strong washing”) makes it possible to simulate use of an H₂ transportation pipe over several years. The procedure used is as described in Table 3.

Table 3 shows the tests used and the classification of the results.

TABLE 2

| Examples and counterexamples | Extractables | Barrier |
|---|---|---|
| Counterexample 1: | >50 | Good |
| PA12-TL/tie/EVOH/tie/PA12-TL | | |
| 400/50/150/50/350 μm | | |
| Counterexample 2: | >30 | Good |
| PA12-NoPlast/tie-NoPlast/EVOH/tie-NoPlast/PA11- | | |
| TL 400/50/150/50/350 μm | | |
| Counterexample 3: | >30 | Good |
| PA12-NoPlast/tie-NoPlast/EVOH/tie-NoPlast/PA610- | | |
| TL 400/50/150/50/350 μm | | |
| Ex. 1: PA12-NoPlast/tie-NoPlast/EVOH/tie- | <5.5 | Good |
| NoPlast/PA610-NoPlast 400/50/150/50/350 μm | | |
| Ex. 2: PA12-NoPlast/tie-NoPlast/EVOH/binder- | <6 | Good |
| NoPlast/PA612-NoPlast | | |
| 400/50/150/50/350 μm | | |
| Ex. 3 PA12-NoPlast/tie-NoPlast/EVOH/tie- | <6 | Good |
| NoPlast/coPA612-6T-NoPlast 400/50/150/50/350 | | |
| μm | | |
| Ex. 4 PA12-NoPlast/tie-NoPlast/EVOH/PA6- | <6 | Good |
| NoPlast 400/50/150/400 μm | | |
| Ex. 5 PA12-NoPlast/tie-NoPlast/EVOH/PA610- | <5.5 | Good |
| NoPlast 400/50/150/400 μm | | |
| Ex. 6 PA610-NoPlast/EVOH/PA610-NoPlast | <5.5 | Good |
| 450/150/400 μm | | |
| Ex. 7 PA11-TL/PA610-NoPlast/EVOH/PA610- | <5.5 | Good |
| NoPlast 150/300/150/400 μm | | |
| Ex. 8 PA11-TL/PA610-NoPlast/EVOH/PA610- | <5.5 | Good |
| NoPlast/PA11-NoPlast | | |
| 150/300/150/250/150 μm | | |
| Ex. 9 PA12-NoPlast/tie-NoPlast/EVOH/tie- | <4.5 | Good |
| NoPlast/PA610-NoPlast 550/50/150/50/200 μm | | |
| Ex. 10 PA12-NoPlast/tie-NoPlast/EVOH24/tie- | <5.5 | Very good |
| NoPlast/PA610-NoPlast | | |
| 400/50/150/50/350 μm | | |
| Ex. 11 PA12-NoPlast/tie-NoPlast/EVOHhi/tie- | <4.5 | Good |
| NoPlast/PA610-NoPlast (550/50/150/50/200 μm) | | |
| Ex. 12 PA12-TL/tie/EVOHhi/tie-NoPlast/PA610- | <5.5 | Good |
| NoPlast 550/50/150/50/200 μm | | |
| Ex. 13 PA12-TL/tie2/EVOHhi/tie2-NoPlast/PA610- | <5.5 | Good |
| NoPlast 550/50/150/50/200 μm | | |
| Ex. 14 PA12-TL/tie/EVOHhi/tie-NoPlast/PA612- | <6 | Good |
| NoPlast 550/50/150/50/200 μm | | |
| Ex. 15 PA12-TL/PPA10T/PA11-NoPlast | <5 | Borderline |
| 600/250/150 μm | | |
| Ex. 16 PA12-TL/tie/EVOH/PA610-NoPlast/PPA10T | <3 | Very good |
| 350/50/100/400/100 μm | | |
| Ex. 17 PA12-TL/tie/EVOH/PPA10T/PA610-NoPlast | <5.5 | Very good |
| 350/50/100/100/400 μm | | |
| Ex. 18 PA12-TL/tie/EVOH/PA610-NoPlast/EFEPc | <3 | Very good |
| 350/50/100/400/100 μm | | |
| Ex. 19 PA11-TL/PA610-NoPlast/EVOH/PA610- | <5.5 | Good |
| NoPlast/PA11cond-NoPlast 400/50/150/300/100 | | |
| μm | | |
| Ex. 20 PA11-NoPlast/EVOH/PA11-NoPlast | <5 | Good |
| 550/150/300 | | |
| Ex. 21 PA11-NoPlast/tie PVDF/PVDF 800/100/100 | <3 | Very good |

TABLE 3

| | Very | | | |
|---|---|---|---|---|
| | good | | Borderline | |
| Properties | (VG) | Good (G) | (FG) | Poor (P) |
| CE10 Biogasoline barrier, | <0.2 | 0.2-1 | 1-3 | >3 |
| 60° C., g/m² · 24 h, barrier 150 | | | | |
| μm thick | | | | |
| Extractables: | <4.5 | 4.5-5.5 | 5.5-6 g/m² | >6 g/m² of |
| this test consisting of a tube | g/m² of | g/m² of tube | of tube | tube surface |
| filled with alcohol-containing | tube | surface | surface | (internal int |
| gasoline of FAM B type at | surface | (internal int | (internal int | surface) |
| 60° C. for 96 hours, then | (internal | surface) | surface) | |
| emptied and filtered into a | int | | | |
| beaker, which is subsequently | surface) | | | |
| left to evaporate and the | | | | |
| residue of which is weighed, | | | | |
| the latter having to be less | | | | |
| than or equal to 6 g/m² (of | | | | |
| tube internal surface) | | | | |

The measurements of permeability to gasolines (biogasoline barrier) are determined at 60° C. according to a gravimetric method with CE10: isooctane/toluene/ethanol=45/45/10 vol %.

The instantaneous permeability is zero during the induction period, then it gradually increases up to an equilibrium value which corresponds to the permeability value under continuous operating conditions. This value, obtained under continuous operating conditions, is considered to be the permeability of the material.

The contaminants extracted into the hydrogen from the various internal layers of the multilayer structures manufactured from the above compositions were quantified according to the standard CSA/ANSI CHMC 2:19:
Multilayer structure with leaktightness layer based on composition I1: <0.5%
Multilayer structure with leaktightness layer based on composition I2: <0.5%
Multilayer structure with leaktightness layer based on composition I3: <0.5%
Multilayer structure with leaktightness layer based on composition I4: <0.5%
Multilayer structure with leaktightness layer based on composition I5: <0.5%
Multilayer structure with leaktightness layer based on composition C1: >3%
Multilayer structure with leaktightness layer based on composition C2: >3%

### Compositions

PA12-TL: denotes a composition based on polyamide 12 with an Mn (number-average molecular weight) of 35 000, containing 6% of plasticizer BBSA (benzylbutylsulfonamide) and 6% of anhydride-functionalized EPR Exxelor VA1801 (Exxon), and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba). The melting point of this composition is 175° C.

PA12-NoPlast=PA12-TL without the plasticizer (the latter is replaced by the same % of PA12).

PA11-TL: denotes a composition based on polyamide 11 with an Mn (number-average molecular weight) of 29 000, containing 5% of plasticizer BBSA (benzylbutylsulfonamide), 6% of impact modifier of ethylene/ethyl acrylate/anhydride type in a ratio by weight of 68.5/30/1.5 (MFI 6 at 190° C. under 2.16 kg), and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba). The melting point of this composition is 185° C.

PA11-NoPlast=PA11-TL without the plasticizer (the latter is replaced by PA11)

PA610-TL=PA610+12% of impact modifier EPR1+organic stabilizer+10% of plasticizer

PA610-NoPlast=PA610-TL without the plasticizer (the latter is replaced by PA610)

PA612-TL=PA612+12% of impact modifier EPR1+organic stabilizer+9% of plasticizer

PA612-NoPlast=PA612-TL without the plasticizer (the latter is replaced by PA612)

PA6-TL=PA6+12% of impact modifier EPR1+organic stabilizer+12% of plasticizer

PA6-NoPlast=PA6-TL without the plasticizer (the latter is replaced by PA6)
PA12: Polyamide 12 with an Mn (number-average molecular weight) of 35 000. The melting point is 178° C. and its enthalpy of fusion is 54 kJ/m²
PA11: Polyamide 11 with an Mn (number-average molecular weight) of 29 000. The melting point is 190° C. and its enthalpy of fusion is 56 kJ/m²
PA610: Polyamide 6.10 with an Mn (number-average molecular weight) of 30 000. The melting point is 223° C. and its enthalpy of fusion is 61 kJ/m²
PA612: Polyamide 6.12 with an Mn (number-average molecular weight) of 29 000. The melting point is 218° C. and its enthalpy of fusion is 67 kJ/m²
PA6: Polyamide 6 with an Mn (number-average molecular weight) of 28 000. The melting point is 220° C. and its enthalpy of fusion is 68 kJ/m²
EPR1: Denotes an EPR functionalized by an anhydride-function reactive group (at 0.5%-1% by weight), with an MFI of 9 (at 230° C., under 10 kg), of Exxellor VA1801 type from Exxon.

Organic stabilizer=1.2% of organic stabilizers consisting of 0.8% of phenol (Lowinox 44B25 from Great Lakes), of 0.2% of phosphite (Irgafos 168 from Ciba) and of 0.2% of UV stabilizer (Tinuvin 312 from Ciba).

Plasticizer=BBSA (benzylbutylsulfonamide)

coPA612-6T-NoPlast=coPA6.12/6.T with 20 mol % of 6.T (thus 80 mol % of 6.12) (this coPA has an MFI 235° C., 5 kg=(melting point=200° C.)+20% of EPR1+orga. stab.

PPA10T=coPA10.T/6T with a molar ratio of 60/40, melting point 280° C.+18% of EPR1+orga. stab.

PA11cond-NoPlast=PA11 with an Mn of 15 000+9% of EPR1+22% of carbon black of Ensaco 200 type

Tie=Composition based on 43.8% of PA612 (as defined elsewhere), on 25% of PA6 (as defined elsewhere) and on 20% of impact modifier of EPR1 type, and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba), and on 10% of plasticizer BBSA (benzylbutylsulfonamide).

Tie-NoPlast=Composition based on 48.8% of PA612 (as defined elsewhere), on 30% of PA6 (as defined elsewhere) and on 20% of impact modifier of EPR1 type, and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba).

Tie2=Composition based on 43.8% of PA610 (as defined elsewhere), on 25% of PA6 (as defined elsewhere) and on 20% of impact modifier of EPR1 type, and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba), and on 10% of plasticizer BBSA (benzylbutylsulfonamide).

Tie2-NoPlast=Composition based on 48.8% of PA610 (as defined elsewhere), on 30% of PA6 (as defined elsewhere) and on 20% of impact modifier of EPR1 type, and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba).

EVOH=EVOH having 32% of ethylene, EVAL FP101B type (Eval)

EVOH24=EVOH having 24% of ethylene, EVAL M100B type (Eval)

EVOHhi=EVOH having 27% of ethylene and impact-modified, EVAL LA170B type (Eval)

PPA10T/6T=coPA10.T/6.T with 40 mol % of 6.T (with an MFI at 300° C., 5 kg=8, and with a melting point of 280° C.)+15% of EPR1+orga. stab.

EFEPc=functionalized and conductive EFEP of Neoflon RP5000AS type from Daikin

Tie PA610+PA6. Denotes a composition based on PA612 (with an Mn of 29 000, and as defined elsewhere) and on 36% of PA6 (with an Mn of 28 000, and as defined elsewhere), and on 1.2% of organic stabilizers (consisting of 0.8% of phenol Lowinox 44B25 from Great Lakes, of 0.2% of phosphite Irgafos 168 from Ciba and of 0.2% of UV stabilizer Tinuvin 312 from Ciba).

The structures exhibiting layers devoid of plasticizer located under the barrier and in particular in contact with the hydrogen present excellent results with regard to the test of extractables, results which are much better than the counterexamples in which the layer in contact with the hydrogen is plasticized.

1. A multilayer tubular structure intended for the transportation of hydrogen, comprising, from the outside toward the inside, at least one barrier layer (1) and at least one internal layer (2) located below the barrier layer,
said internal layer (2) or the combination of the layers (2) and of the other optional layers located below the barrier layer containing, on average, from 0% to 1.5% by weight of plasticizer, with respect respectively to the total weight of the composition of the layer (2) or to the total weight of the combination of the compositions of the layers (2) and of the other optional layers located below the barrier layer,
said internal layer (2) exhibiting a content of extractables, determined according to the standard CSA/ANSI CHMC 2:19, of less than or equal to
3% by weight of the sum of the constituents of said composition,
said internal layer (2) predominantly comprising at least one polyamide of aliphatic type or consisting of more than 75% of aliphatic units, said aliphatic polyamide being chosen from:
a polyamide, denoted A, exhibiting a mean number of carbon atoms per nitrogen atom, denoted C_{A}, of from 4 to 8.5;
a polyamide, denoted B, and a mean number of carbon atoms per nitrogen atom, denoted C_{B}, of from 7 to 10;
a polyamide, denoted C, exhibiting a mean number of carbon atoms per nitrogen atom, denoted C_{C}, of from 9 to 18;
with the proviso that, when said internal layer (2) comprises at least three polyamides, one at least of said polyamides A, B and C is excluded.

2. The multilayer tubular structure as claimed in claim 1, in which said barrier layer is chosen from an EVOH layer, a fluoropolymer layer, and a PPA layer.

3. The multilayer tubular structure as claimed in claim 1, in which said internal layer (2) or each of the layers (2) and of the other optional layers located below the barrier layer is (are) devoid of plasticizer.

4. The multilayer tubular structure as claimed in claim 1, in which at least one, more external, layer (3), located above the barrier layer, is present, said external layer (3) predominantly comprising at least one polyamide of aliphatic type or consisting of more than 75% of aliphatic units.

5. The multilayer tubular structure as claimed in claim 4, in which said external layer (3) comprises from 0% to 15% of plasticizer, with respect to the total weight of the composition of the layer (3), or in which the combined external layers comprise, on average, from 0% to 5% of plasticizer.

6. The multilayer tubular structure as claimed in claim 4, in which at least one second external layer (3′) located above the barrier layer is present, said layer (3′) being plasticized.

7. The multilayer tubular structure as claimed in claim 6, in which the layer (3′) is the outermost layer and is the only layer which is plasticized, the layer(s) (3) being devoid of plasticizer.

8. The multilayer tubular structure as claimed in claim 6, in which at least one layer (4) is present, said layer (4) not containing more than 15% by weight of plasticizer, with respect to the total weight of the constituents of the layer (4);
said layer (4) predominantly comprising at least one polyamide of aliphatic type or consisting of more than 75% of aliphatic units, said aliphatic polyamide being chosen from:
a polyamide, denoted A, exhibiting a mean number of carbon atoms per nitrogen atom, denoted C_{A}, of from 4 to 8.5;
a polyamide, denoted B, and a mean number of carbon atoms per nitrogen atom, denoted C_{B}, of from 7 to 10;
a polyamide, denoted C, exhibiting a mean number of carbon atoms per nitrogen atom, denoted C_{C}, of from 9 to 18;
with the proviso that, when said layer (4) comprises at least three polyamides, at least one of said polyamides A, B and C is excluded,
or said layer (4) is a tie layer, the thickness of which represents up to 15% of the (MLT) structure,
said layer (4) being located between the barrier layer (1) and the internal layer (2) and/or between the external layer (3) and the barrier layer (1).

9. The multilayer tubular structure as claimed in claim 8, in which a layer (4′) is present, said layer (4′) predominantly comprising at least one polyamide of aliphatic type or consisting of more than 75% of aliphatic units, said aliphatic polyamide being chosen from:
a polyamide, denoted A, exhibiting a mean number of carbon atoms per nitrogen atom, denoted C_{A}, of from 4 to 8.5;
a polyamide, denoted B, and a mean number of carbon atoms per nitrogen atom, denoted C_{B}, of from 7 to 10;
a polyamide, denoted C, exhibiting a mean number of carbon atoms per nitrogen atom, denoted C_{C}, of from 9 to 18;
with the proviso that, when said layer (4′) comprises at least three polyamides, one at least of said polyamides A, B and C is excluded,
or said layer (4′) is a tie layer, the thickness of which represents up to 15% of the (MLT) structure,
it being possible for said at least one polyamide of said layer (4′) to be identical to or different from said polyamide of the layer (4);
said layer (4′) being located between the external layer (3) and the barrier layer (1) and said tie layer (4) being located between the barrier layer (1) and the internal layer (2).

10. The multilayer tubular structure as claimed in claim 4, in which the polyamide of the internal layer (2) or the polyamide of the external layer (3) is a completely aliphatic polyamide.

11. The multilayer tubular structure as claimed in claim 4, in which a second barrier layer (5) is present, said second barrier layer (5) being adjacent or not adjacent to the first barrier layer (1) and located below said barrier layer (1).

12. The multilayer tubular structure as claimed in claim 2, in which said barrier layer is an EVOH layer comprising up to 27% of ethylene.

13. The multilayer tubular structure as claimed in claim 2, in which said barrier layer is an EVOH layer comprising an impact modifier.

14. The multilayer tubular structure as claimed in claim 11, in which the barrier layer (1) is an EVOH layer and the second barrier layer (5) is a PPA or fluoropolymer layer, the fluoropolymer being in particular of ETFE, EFEP or CPT type.

15. The multilayer tubular structure as claimed in claim 1, in which the polyamide of the internal layer (2) is a composition based on a polyamide chosen from A, B or C.

16. The multilayer tubular structure as claimed in claim 4, in which the polyamide of the external layer (3) is a polyamide chosen from B or C.

17. The multilayer tubular structure as claimed in claim 1, in which the polyamide of the internal layer (2) is a composition based on a polyamide chosen from A, B or C, and the polyamide of the external layer (3) is a polyamide chosen from B or C.

18. The multilayer tubular structure as claimed in claim 1, in which the polyamide of the internal layer (2) or of one at least of the other layers (2) is a conductive polyamide.

19. The multilayer tubular structure as claimed in claim 9, in which the polyamide of the layer (4) and/or (4′) is chosen from the binary blends: PA6 and PA12, PA6 and PA612, PA6 and PA610, PA12 and PA612, PA12 and PA610, PA1010 and PA612, PA1010 and PA610, PA1012 and PA612, PA1012 and PA610, and the ternary blends: PA6, PA610 and PA12; PA6, PA612 and PA12; PA6, PA614 and PA12.

20. The multilayer tubular structure as claimed in claim 9, in which at least one of the layers (2), (3), (4) and (4′) comprises at least one impact modifier and/or at least one additive.

21. The multilayer tubular structure as claimed in claim 4, in which the structure comprises three layers in the following order: (3)//(1)//(2), the layers (3) and/or (2) not containing more than 1.5% by weight of plasticizer, with respect to the total weight of the composition of each layer.

22. The multilayer tubular structure as claimed in claim 6, in which the structure comprises four layers in the following order: (3′)//(3)//(1)//(2), the layer (2) and/or (3) not containing more than 1.5% by weight of plasticizer, with respect to the total weight of the composition of each layer.

23. The multilayer tubular structure as claimed in claim 11, in which the structure comprises five layers in the following order:
(3′)//(3)//(1)//(5)//(2), in which the layer (1) is an EVOH layer, the layer (5) is a PPA layer, the layer (2) not containing more than 1.5% by weight of plasticizer, with respect to the total weight of the composition of each layer; or
(3′)//(3)//(1)//(2)//(5), in which the layer (1) is an EVOH layer, the layer (5) is a PPA layer, the layer (2) not containing more than 1.5% by weight of plasticizer, with respect to the total weight of the composition of each layer; or
(3)//(4′)//(1)//(4)//(2), the layer (2) and (4) not containing more than 1.5% by weight of plasticizer, with respect to the total weight of the composition of each layer.

24. The multilayer tubular structure as claimed in claim 8, in which the structure comprises the layers in the following order:
(3′)//(3)//(4′)//(1)//(4)//(2), the layer (2) and (4) not containing more than 1.5% by weight of plasticizer, with respect to the total weight of the composition of each layer.

25. The multilayer structure as claimed in claim 1, wherein the multilayer structure comprises a polyamide connector at one and/or the other of its ends, said connector being welded to said structure.

26. The structure as claimed in claim 25, wherein the polyamide of said connector is chosen from PA6, PA66, PA6/66, PA11, PA610, PA612 or PA1012.

27. A method of using the multilayer tubular structure as defined in claim 1 for the transportation of hydrogen.
